(19) United States
(12) Patent Application Publication
(10) Pub. No.: US 2020/0162434 A1
(43) Pub. Date: May 21, 2020

(54) SECURE AND ENCRYPTED HEARTBEAT PROTOCOL

(71) Applicant: Arete M Pte. Ltd., Singapore (SG)

(72) Inventors: Pen San Tang, Singapore (SG); Tse Cheng Lim, Singapore (SG); Nagajothi Nagappan, Singapore (SG); Liang Zee Wee, Singapore (SG)

(73) Assignee: Arete M Pte. Ltd., Singapore (SG)

(21) Appl. No.: 16/619,672

(22) PCT Filed: Jun. 5, 2018
(86) PCT No.: PCT/SG2018/050276

§ 371 Date: Dec. 5, 2019

(30) Foreign Application Priority Data
Jun. 5, 2017 (SG) 10201704555V

(51) Int. Cl. H04L 29/06; H04L 29/08; H04L 12/26; H04L 29/14; H04W 12/00; H04W 12/04; H04L 9/08; B64C 39/02

(52) U.S. Cl. CPC H04L 63/045; G05D 1/101; H04L 65/608; H04L 43/10; H04L 69/40; H04L 67/125; H04W 12/001; H04L 63/166; H04L 63/18; H04W 12/0401; H04L 9/0866; B64C 39/024; H04L 2209/80; H04L 2209/84; B64C 2201/14; H04L 67/145

(57) ABSTRACT

A heartbeat protocol communication method for an unmanned vehicle system, a method for secure hybrid cryptographic communication, and a method for encrypted communication during one or more communication sessions with a device are provided. The unmanned vehicle system includes an unmanned vehicle and a control platform and the method includes the unmanned vehicle transmitting heartbeat data at regular periodic predetermined time intervals, the heartbeat data comprising keep alive application data comprising real-time information pertinent to the unmanned vehicle and/or the control platform determining at regular periodic predetermined time intervals whether heartbeat data transmitted by the unmanned vehicle is received and the control platform transmitting an acknowledgement response to the unmanned vehicle each time the heartbeat data is received at a regular periodic predetermined time interval. The method further includes the control platform transmitting a heartbeat failure alert to the unmanned vehicle in response to determining no heartbeat data is received from the unmanned vehicle for a predetermined number of the regular periodic predetermined time intervals.

### TECHNICAL FIELD

The present invention generally relates to communication systems, and more particularly relates to methods and devices for communication using a secure heartbeat protocol.

### BACKGROUND OF THE DISCLOSURE

Autonomous systems have been developed to handle various and diverse tasks. A functional element of many of such systems is one or more unmanned machine, such as a robot, an Unmanned Aerial Vehicle (UAV), or an Unmanned surface vehicle (USV). Control of such unmanned machines is made possible by a central command platform with data and command communication capabilities. Such communication is typically enabled by integrating a transceiver into the unmanned machines as a communication module. Thus, the unmanned machines are able to send a secured heartbeat message, live geolocation data i.e., GPS location data, video stream data etc., to the central platform and able to receive commands, secured heartbeat response/reply from the central platform for control thereof.

However, in today's world, communication is subject to intrusion and attack, such as distributed denial of service (DDoS) attacks, data interception and thefts. Such attacks are becoming more common and frequent because when data and command packets travel across a wired or wireless network, such packets are susceptible to being read, altered, or hijacked. Hijacking of data occurs when an attacker intercepts a network traffic session and accesses one of the session endpoints.

Presently there are no mechanisms to monitor a connection between a central platform and an unmanned machine to determine if a communication link therebetween is still active. Furthermore, there are no mechanisms for an unmanned machine to alert a server or the central platform to occurrences or potential problems relating to such attacks, hijacking or thefts.

Thus, what is needed is a failsafe monitoring system which provides unmanned machine communication with a secured heartbeat protocol. Furthermore, other desirable features and characteristics will become apparent from the subsequent detailed description and the appended claims, taken in conjunction with the accompanying drawings and this background of the disclosure.

### SUMMARY

In accordance with the present invention, a heartbeat protocol communication method for an unmanned vehicle system is provided. The unmanned vehicle system includes an unmanned vehicle and a control platform and the method includes the unmanned vehicle transmitting heartbeat data at regular periodic predetermined time intervals, the heartbeat data comprising keep alive application data comprising real-time information pertinent to the unmanned vehicle.

In accordance with another aspect of the present invention, a heartbeat protocol communication method for an unmanned vehicle system is provided. The unmanned vehicle system includes an unmanned vehicle and a control platform and the method includes the control platform determining at regular periodic predetermined time intervals whether heartbeat data transmitted by the unmanned vehicle is received and the control platform transmitting an acknowledgement response to the unmanned vehicle each time the heartbeat data is received at a regular periodic predetermined time interval. The method further includes the control platform transmitting a heartbeat failure alert to the unmanned vehicle in response to determining no heartbeat data is received from the unmanned vehicle for a predetermined number of the regular periodic predetermined time intervals.

In accordance with a further aspect of the present invention, a heartbeat protocol communication method for an unmanned vehicle system is provided. The unmanned vehicle system includes an unmanned vehicle transmitting and a control platform receiving heartbeat data on a dedicated internet protocol (IP) communication network and the method includes the unmanned vehicle transmitting heartbeat data on a dedicated transport layer security/secure sockets layer (TSL/SSL) secure channel established with the control platform in a transport layer of the IP communication network.

In accordance with an additional aspect of the present invention, a method for secure hybrid cryptographic communication is provided. The method includes encrypting message data encryption utilizing symmetric cryptography and further encrypting the message data utilizing asymmetric cryptography.

In accordance with another aspect of the present invention, a method for encrypted communication during one or more communication sessions with a device is provided. The method includes generating a passphrase in response at least to a unique piece of information associated with the device and a unique piece of information associated with the one or more communication sessions and generating a first session key by performing a first key derivation function on the passphrase. The method further includes encrypting data to be transmitted during the one or more communication sessions and decrypting data received during the one or more communication sessions in response to the second session key.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to illustrate various embodiments and to explain various principles and advantages in accordance with a present embodiment.

FIG. 1 depicts a schematic illustration of an exemplary system for flight control of an unmanned aerial vehicle (UAV) in accordance with a present embodiment.

FIG. 2 depicts a schematic illustration of exemplary internet protocol (IP) based network communication between the control platform and the UAV in the system of FIG. 1 in accordance with the present embodiment.

FIG. 3 depicts a schematic illustration of exemplary client/server communication in accordance with the present embodiment.

FIG. 4 depicts a schematic illustration of an exemplary key derivation function in the client/server communication of FIG. 3 in accordance with the present embodiment.

FIG. 5 depicts a table of encryption and decryption using session keys derived by the key derivation function of FIG. 4 in accordance with the present embodiment.

FIG. 6 depicts a table illustrating digital signing and encryption in accordance with the present embodiment.

FIG. 7 depicts a flow chart of an exemplary digital signing and encryption process at the sender side in accordance with the present embodiment.

FIG. 8 depicts a flow chart of an exemplary signature verify and decryption process at the receiver side in accordance with the present embodiment.

FIG. 9 depicts an illustration of a first exemplary heartbeat protocol operation of the system of FIG. 1 in accordance with the present embodiment.

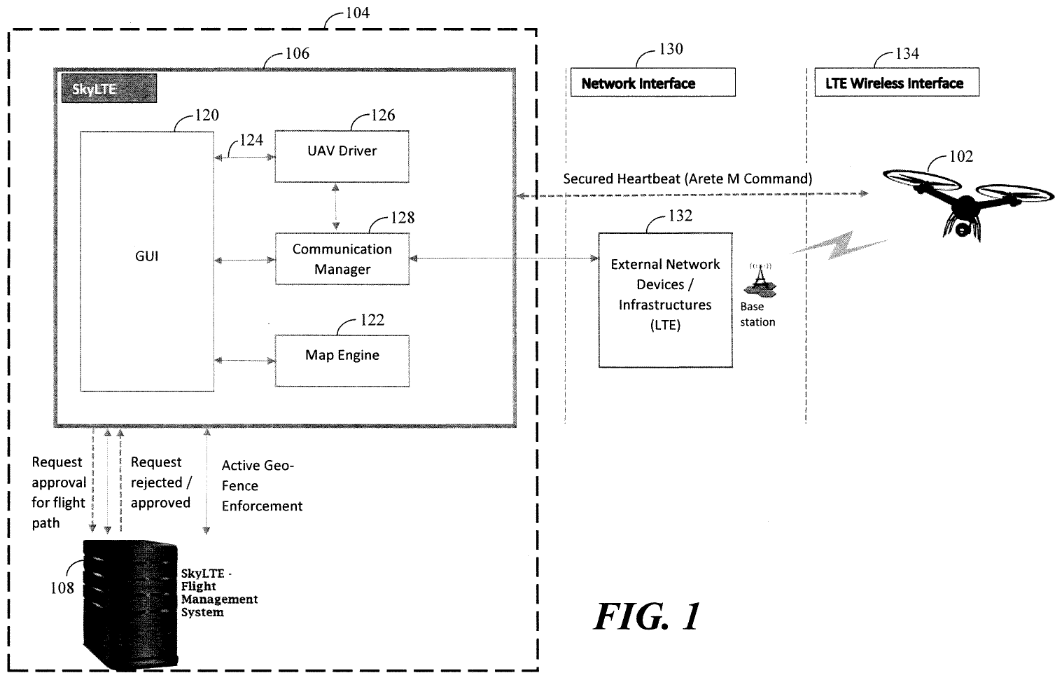

And FIG. 10 depicts an illustration of a second exemplary heartbeat protocol operation of the system of FIG. 1 in accordance with the present embodiment wherein a predefined failsafe procedure operates in the absence of appropriate heartbeat data.

Skilled artisans will appreciate that elements in the figures are illustrated for simplicity and clarity and have not necessarily been depicted to scale.

### DETAILED DESCRIPTION

The following detailed description is merely exemplary in nature and is not intended to limit the invention or the application and uses of the invention. Furthermore, there is no intention to be bound by any theory presented in the preceding background of the invention or the following detailed description. It is the intent of the present embodiment to present a real-time mission critical software platform to control one or more unmanned machines via a dedicated Long-Term Evolution (LTE) network. A message sender device will generate a session key (SKI) which is generated from a passphrase of an ID of the associated unmanned machine, such as an Unmanned Aerial Vehicle (UAV) ID, and a unique piece of information associated with the communication session, such as information identifying a present location (i.e., Location ID) for the UAV by a novel key generation function (KGF). After hand shaking between the unmanned machine and a LTE server, a communication channel is established. To ensure that the connection between the UAV and the LTE server is alive and kicking, a novel heartbeat protocol is provided in an application layer of the communication channel in accordance with the present embodiment which advantageously enables the server to determine that the communication channel between the UAV and the LTE server is alive.

To protect unmanned machine data from interception by attackers in accordance with the present embodiment, a unique secure handshake protocol has been developed to ensure information security in an internet protocol network involving an unmanned machine. The secure handshake protocol includes a strong and unique secure session key, SK1, which is generated from a passphrase of a first piece of data unique to the unmanned machine and a second piece of data associated with the unmanned machine coincident with the session key generation process. In addition, a hybrid cryptography mechanism combining asymmetric keys and symmetric keys is used in accordance the present embodiment to enhance secure transfer of data over the network.

The present embodiment presents in one aspect a dedicated enterprise grade private LTE network to offer mission critical communication services to a range of industries such as public transportation, public safety, security and surveillance. The LTE network preferably utilizes the 1.79 GHz-1.80 GHz frequency spectrum for communication, a frequency spectrum which has traditionally been utilized as a guard band or center gap for telecommunication networks. In addition, fourth generation LTE networks are based on a packet switching system, which is a digital networking communications method that groups all transmit data into packets which are transmitted via an IP-based network architecture.

Since the LTE networks are an IP-based access technology, use of an LTE network in accordance with the present embodiment naturally inherits TCP/IP protocol security issues. A non-secured LTE network could lead to information leaks, information disclosures, information modifications or losses, Denial-of-Service (DoS) attacks or even interruption of services. Thus, security issues have always been a main focus of improvements in IP networking to protect against cyber threats that can affect the normal work and communication of an LTE network.

Secure sockets layer (SSL) cryptographic protocols are used to provide communications security over the TCP layers in IP network by providing an encrypted end-to-end data path between a client and a server regardless of what platform or operating system is used at either end. During an SSL handshake, both the client and the server will exchange their key information by public key cryptography (PKC) using public key infrastructure (PKI) for their mutual authentication (i.e., server authentication and client authentication). Public key infrastructure (PKI) is a cryptography mechanism that provides information security services which is based on an asymmetrical key algorithm and serves as a foundation and a core for establishing the network security system. A PKI certificate mechanism provides an infrastructure for secure and standardized key management. The core of the PKI certificate mechanism lies in the management of digital certificates, including the issue, distribution, update, and cancellation of such certificates. In accordance with the present embodiment, the digital certificates are compliant with ITU-T X509 standards.

Referring to FIG. 1, a schematic illustration 100 depicts an exemplary system for flight control of a UAV 102 in accordance with the present embodiment utilizing a dedicated LTE control platform 104. The control platform 104 includes a command and control SkyLTE platform 106, and a SkyLTE Flight Management System 108.

The command and control SkyLTE platform 106 includes a graphic user interface (GUI) layer 120 built on a mapping engine 122 and an interface 124 to pluggable UAV driver modules 126. The function of the UAV driver modules 126 is to control the UAV 102 and obtain data (e.g., pictures, video stream) from the UAV 102. The command and control platform 106 also includes a communication manager 128 whose role is to establish a wireless communication link with the UAV 102 via an interface 130 to a network 132 (e.g., internet) and a wireless communication network such as an LTE wireless network 134 for command transmission, data retrieval, identification of unmanned machines and other unmanned machine communications.

While the exemplary system of FIG. 1 utilizes the UAV 102, those skilled in the art will understand that the present system can be used for any unmanned machine such as robots, UAVs, or unmanned surface vehicles. By integrating an LTE transceiver into the unmanned machine(s) as a communication module, the unmanned machine(s) will be able to receive commands from the central platform 104 and be controlled over a cellular network such as the LTE wireless network 134. Those skilled in the art will also realize that while the command and control SkyLTE platform 106, and SkyLTE Flight Management System 108 could be hardwired together, they could also be connected via a network such as the internet.

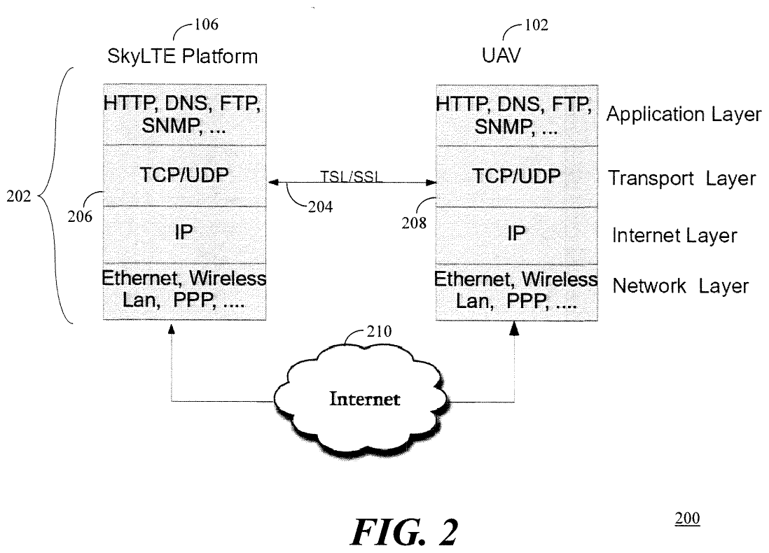

Referring to FIG. 2, a schematic illustration 200 depicts exemplary communication over a dedicated LTE link between the command and control SkyLTE platform 106 and the UAV 102 in accordance with the present embodiment. While a dedicated LTE link is disclosed in the exemplary embodiment discussed, any digital networking communication system which uses packet switching technology could be used. Packet switching technology is a digital networking communication method that groups all transmit data into packets and transmits these packets across the internet via an internet protocol (IP) based network architecture 202. Transport layer security/secure sockets layer (TSL/SSL) cryptographic protocols 204 (referred to hereinafter as SSL) are used to provide communication security at the transport layer (TCP/UDP) 206, 208 in the IP-based architecture. The TSL/SSL cryptographic protocol 204 communication is reserved for heartbeat communication as described hereinafter. Secure communication between the UAV 102 and the control platform 106 for other matters takes place through the internet 210 as internet protocol (IP) communication.

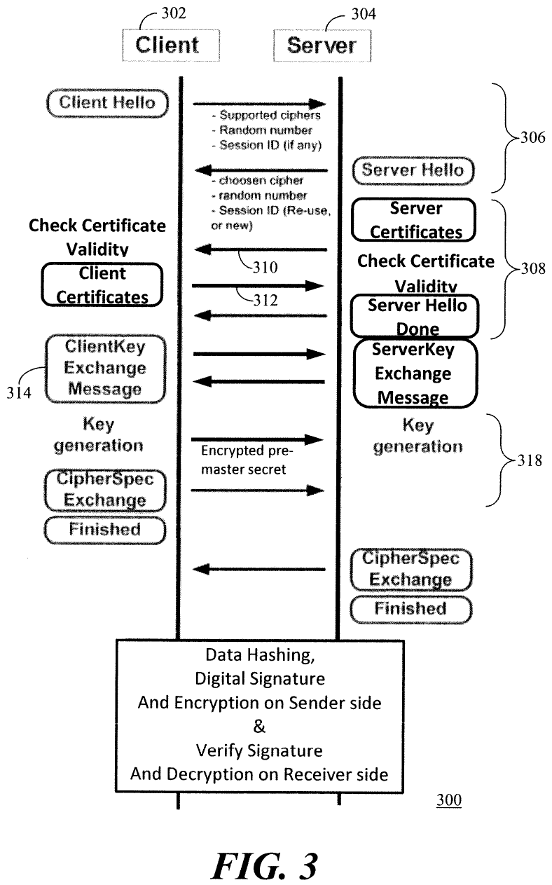

For secure IP communication, both the UAV 102 and the control platform 106 will exchange key information using public key cryptography/asymmetric keys (PKC) for mutual authentication. FIG. 3 depicts a schematic illustration 300 of exemplary client/server communication between the UAV 102 and command and control SkyLTE platform 106 in accordance with the present embodiment which includes the SSL 204 handshake. As communication between the UAV 102 and the control platform 106 is two-directional, either the UAV 102 or the control platform 106 can serve as the “Client” 302 or the “Server” 304 in the client/server communication illustration 300 depending upon which entity initiates the communication.

Before flying, the UAV 102 is required to obtain clearance to fly upon a new predefined flight path. In accordance with the present embodiment, a new flight path application is submitted to the SkyLTE Flight Management System 108 via the command and control SkyLTE platform 106. If the new flight path satisfies all requirements of the geo-fence regulations and the flight path authority regulations, the flight path will be approved by the SkyLTE Flight Management System 108. Once the UAV 102 obtains clearance to fly in accordance with the flight path application submitted via the control platform 106 and approved by the SkyLTE Flight Management System 108, a token (i.e., random number) will be issued to the UAV 102 via the control platform 106 through a LTE network TCP/IP socket connection as shown in FIG. 2 and a handshake protocol as shown in the flowchart 300 will commence. The handshake protocol is an automated process of negotiation that dynamically sets parameters of a communication channel established between two entities (i.e., the control platform 106 and the UAV 102).

During initial connection, the server and client will do a software handshake 306 by sending codes such as “synchronize”(SYN) and “acknowledge” (ACK) in a TCP/IP transmission. The software handshake 306 is followed by a SSL handshake 308. During the SSL handshake 308, the control platform 106 and the UAV 102 both perform the following tasks: establish a cipher suite to use between the control platform 106 and the UAV 102, authentication of the control platform 106 by the control platform 106 sending 310 its certificate to the UAV 102 to verify that the control platform's 106 certificate was signed by a trusted certification authority, authentication of the UAV 102, if required, through the UAV 102 sending 312 its own certificate to the control platform 106 to verify that the UAV's 102 certificate was signed by a trusted certification authority, and exchange of key information 314, 316 using public key cryptography after mutual authentication leading to the generation of a session key 318. The symmetric session key is shared by both parties and is used in all subsequent communication.

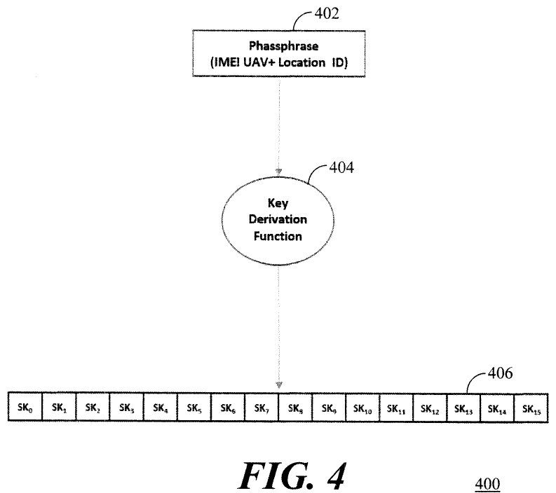

Mutual authentication in accordance with the present embodiment leads to the client 302 generating 318 a session key using a passphrase by a key derivation function (KDF) which is a function that transforms the passphrase input into a first session key (SK1). Referring to FIG. 4, a schematic illustration 400 depicts an exemplary key derivation session 318 in accordance with the present embodiment. The passphrase 402 is derived using two pieces of data associated with the unmanned machine. Preferably a first one of the pieces of data is a unique piece of data permanently associated with the unmanned machine and a second one of the pieces of data that is temporarily assigned to the unmanned machine coincident with the key derivation session 318. In accordance with the present embodiment, the transceiver of the UAV 102 has an International Mobile Equipment Identity (IMEI) permanently associated therewith. In generating the passphrase 402, the IMEI UAV serves as the first one of the pieces of data. During the flight of the UAV 102, a location identification (Location ID) is determined at the time of key derivation and, in accordance with the present embodiment, the Location ID serves as the second one of the pieces of data to generate the passphrase 402. A key derivation function 404 then generates a multi-byte session key as a session key (SK1) 406. The session key (SK1) is also known as a symmetric key, because the same session key is used for both encryption and decryption. While the session key (SK1) 406 is sixteen bytes (a block size of 128 bits), those skilled in the art will realize that a session key of any number of bytes will serve the purpose of the SK1 406, though the number of bytes needs to be balanced between a greater number of bytes providing a more secure session key versus a smaller number of bytes providing quicker session key verification and manipulation.

In accordance with the present embodiment, the session key is more secure by having a self-expiring session key. At regular periodic predetermined intervals (e.g., T minutes), the existing session key (SK1) expires. This provides additional security as the sender will need to generate a new session key (i.e., SK2) based upon the unique device information (e.g., the IMEI) and a new present location determined at the time of generating the new session key (SK2). Once the new session key is generated, it will be shared between the sender and receiver and used for data encryption and decryption for the next predetermined interval (e.g., T minutes). After the periodic predetermined interval, the existing session key (i.e., SK2) will expire and a new session key (e.g., SK3) will be generated. This cycle of regenerating session keys every periodic predetermined interval will continue for the communication session (e.g., for the flight of a UAV) and, in accordance with the present embodiment, each session key (e.g. SK1, SK2, SK3, etc.) is generated from Location IDs (i.e., identification information associated with a present location when the session key is generated) which are unique to the communication session.

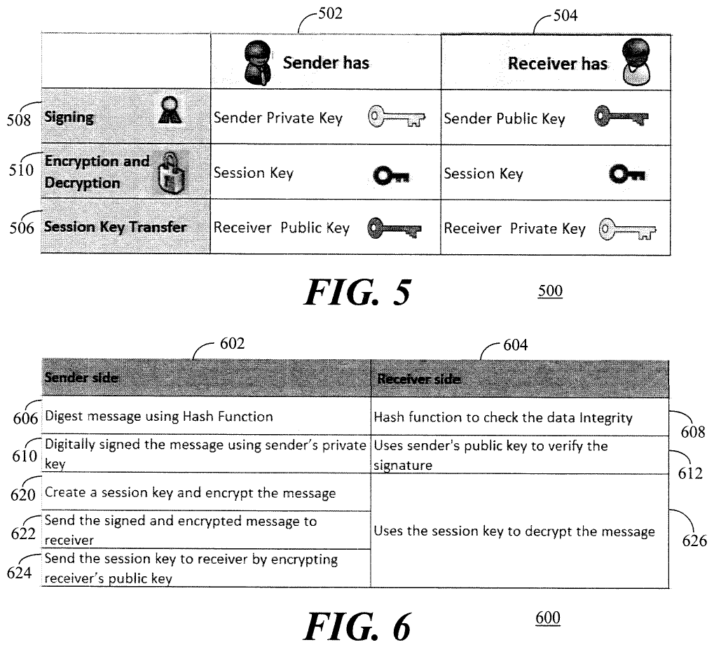

Referring to FIG. 5, a table 500 of encryption and decryption using session keys and public and private keys in accordance with the present embodiment. Those skilled in the art will realize that either the control platform 106 (e.g., the server) or the UAV 102 (e.g., the client) can assume the role of either the sender 502 or the receiver 504. As described in FIG. 4, the session key (SK1) is a secure and unique key generated for each communication session and is transferred between the sender 502 and the receiver 504 by the party generating the session key (SK1) 406, typically the UAV 102, assuming the role of sender and encrypting 506 the session key (SK1) 406 before transmitting it to the receiver 504. For data, digital signatures are based on public key cryptography (PKC), also known as asymmetric cryptography. In PKC, using a RSA algorithm will generate two keys, one private key and one public key, and both are mathematically linked. Each of the sender 502 and the receiver 504 has a private key known only to the owner of the private key and a public key known to both the sender 502 and the receiver 504.

To authenticate the source of messages and data integrity, the message or data needs to be digitally signed 506. Referring to the table 500, in accordance with the present embodiment, the sender 502 utilizes the sender private key for digital signing 508 and the receiver 504 uses the sender's public key for digital signing 508. As described above, both parties have the session key (SKI) 406 and the same session key (SK1) 406 is used for both encryption and decryption 510.

In a public key encryption system, the encryption/signing process as described above uses a conventional RSA algorithm which involves modular exponentiation. Signing large data through modular exponentiation is computationally expensive and time consuming. Instead of signing data directly by a signing algorithm, a hash of data is typically created. The cryptographic hash function converts a message into a digest and the hash of the data is a relatively small digest of the data, hence signing a hash is more efficient than signing the entire data. This saves time since hashing is much faster than signing

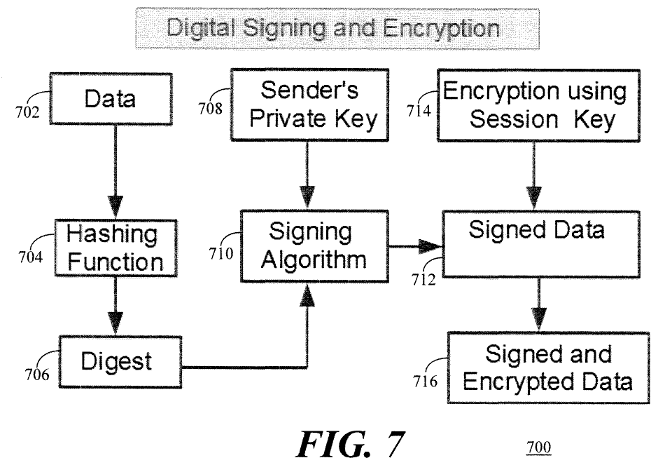

Referring to FIG. 6, a table 600 depicts in tabular format digital signing and encryption as well as secure message transfer from the sender side 602 to the receiver side 604 in accordance with the present embodiment. The symmetric key (i.e., the session key (SK1) 406 which both parties have is used in all subsequent communication during the session as shown in the table 600. To create a digital signature, the private key is used to encrypt the hash. The encrypted hash along with other information, such as the hashing algorithm becomes the sender's digital signature. To verify the digital signature, the receiver uses the sender's public key to authenticate the digital signature. The sender side 602 utilizes the cryptographic hash function to convert a message into a digest 606 and the receiver side utilizes the hash function to verify data integrity 608 for secure communication. In addition, since the public key and the private keys are mathematically linked, the sender 602 digitally signs 610 messages using the sender's private key and the receiver 604 verifies 612 the sender's digital signature using the sender's public key. Further, in accordance with the present embodiment, the sender side 602 (e.g., the UAV 102) creates 620 the session key (SK1) 406 and uses the session key (SK1) 406 to encrypt 620 messages sent to the receiver side 604 (e.g., the control platform 106). The sender side 602 then digitally signs the encrypted message and sends 622 the digital signature and the encrypted message to the receiver side 604. Further, the sender side sends 624 the session key (SKI) 406 to the receiver side 604 by encrypting it with the receiver side's public key. The receiver side 604 recovers the session key (SK1) 406 and uses it to decrypt 626 messages the encrypted messages received from the sender side 602.

To ensure data confidentiality, integrity, authentication and non-repudiation while data is transferred (e.g., transferred over the IP network 200 between the control platform 106 and the UAV 102), in accordance with the present embodiment a hybrid cryptography is used combining symmetric key cryptography using the session key (SK1) 406 for encryption/decryption at both the sender side 602 and the receiver side 604 with asymmetric keys cryptography utilizing digital signing based on public/private keys.

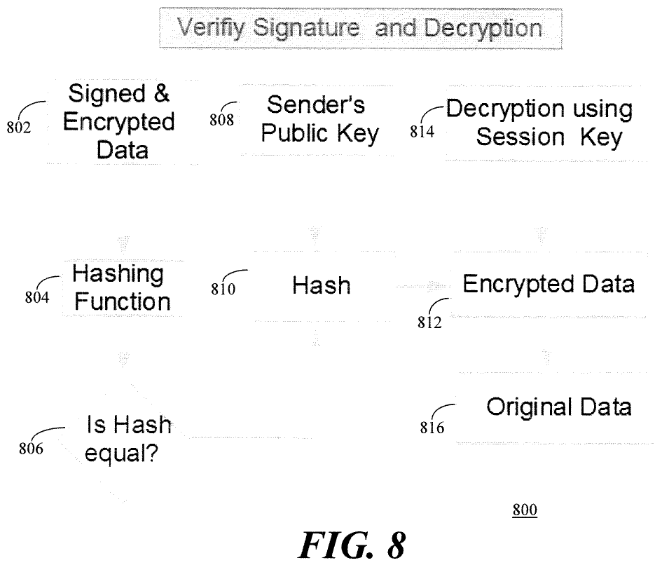

Referring to FIG. 7, a flowchart 700 depicts a message digest, digital signature and encryption procedure in accordance with the present embodiment. For secure communications, when the control platform 106 or the UAV 102 is a message sender to the other, the message sender wants to be assured that the receiver knows the message came from the message sender and no one else. To accomplish this, the message sender creates a digest and signs and encrypts the message in the hybrid cryptosystem of the present embodiment. An exemplary digital signing and encryption procedure is depicted in the flowchart 700. The message sender converts message data 702 into a message digest 706 using a cryptographic hash function 704 The input to the hash function 704 is of arbitrary length but the output is always of predefined fixed length. The values returned by the hash function 704 are called the message digest 706 or simply hash values. As a non-limiting example, either MD5 or SHA1 algorithms may he used for the hash function 704.

The message sender then uses the sender's private key 708 and a signing algorithm 710 to sign the digest a generate the signed data 712. Those skilled in the art will realize that this process is called message signing or digital signature and a RSA asymmetric algorithm can use the private key 708 to sign the message thereby allowing a PKC concurrently-generated public key to verify the signature. The public key is known to others, but the private key is unique and only known to the message sender. For each communication session, the message sender periodically generates a fresh session key which is unique and strong against attack for data encapsulation in accordance with the present embodiment as described hereinabove in relation to FIG. 4. The message sender then encrypts the signed data 712 using the generated session key 714 to generate a signed and encrypted message 716. If the communication is the first in the communication session with a new session key, the session key is also encrypted in accordance with the key encapsulation scheme, using the receiver's public key 506 and sent along with the signed and encrypted message 716 to the receiver.

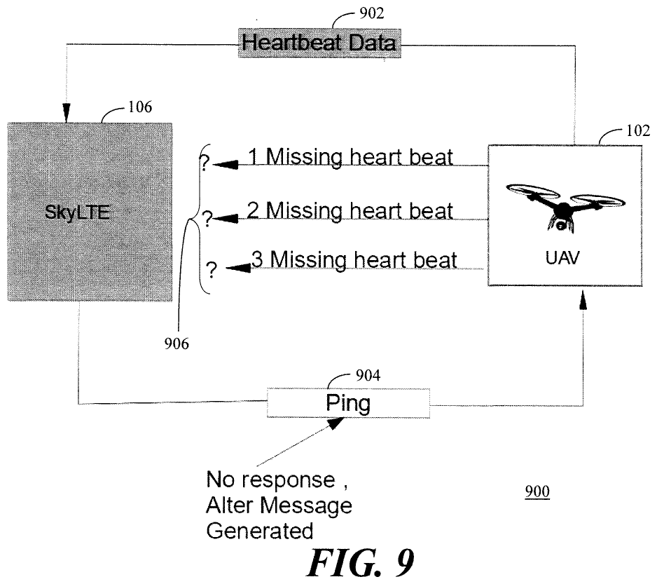

Referring to FIG. 8, a flowchart 800 depicts a process for verification of the sender signature and decryption of hybrid cipher text in accordance with the present embodiment. The receiver receives the signed and encrypted data 802 and authenticates that it is received from an authorized sender by performing the hashing function 804 and only if the has is equal 806 continuing to process the received data. The process then verifies the hash (i.e., digital signature) 810 using the previously shared sender's public key 808. After ensuring the validity of the signature 810, then receiver uses its private key to decrypt the symmetric key 506 contained in the key encapsulation segment (if the communication is the first data exchange in a communication session). For all subsequent communications, the encrypted data 812 is decrypted using the session key 814 to regenerate the original message data 816. Thus, in accordance with the present embodiment, in the unlikely event that someone intercepts and decrypts the session key, that session key cannot be used to deduce any future keys because the session keys automatically expire after the current communication session is over.

In accordance with another aspect of the present embodiment, to ensure the connection between the UAV 102 and control platform 106 is “alive and kicking”, a unique heart-beat process is design in the TCP/IP communication application layer such that the control platform 106 uses “heartbeats” to monitor communication channels between the UAV 102 and the control platform on the dedicated TSL/SSL connection 204 (FIG. 2). The control platform 106 uses the “heartbeats” heartbeats to monitor a connection between the UAV 102 and control platform 106 and determine that the connection is still alive, to determine any failure of the UAV 102, to alert administrators (e.g., at the flight authority platform 112) to potential problems involving the flight of the UAV 102 and to load balance the system.

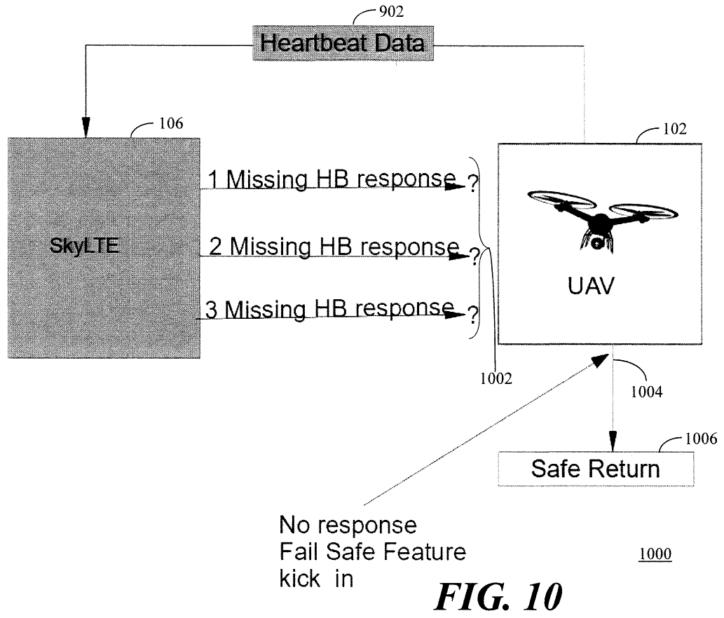

Referring to FIG. 9, an illustration 900 depicts heartbeat communication between the control platform 106 and the UAV 102 in accordance with the present embodiment. Every periodic predetermined interval (e.g., T milliseconds), the UAV 102 sends and the control platform 106 expects to receive a proprietary heartbeat data packet 902 including keep alive application data and the UAV 102 expects a predetermined response from the control platform 106. The packet of data is sent between the UAV 102 and the control platform 106 on a regular basis separated by the predetermined time interval Tms using a dedicated communication channel 204 with ports defined in the transport layer 206, 208. The heartbeat data 902 includes real-time UAV 102 pertinent information. In accordance with the present embodiment, the real-time pertinent information (i.e., the heartbeat data 902) includes current Geographic Information System (GIS) information of the UAV 102 that includes latitude and longitude coordinates and altitude details. In a system where the approved flight space is made up of predefined three-dimensional polygons, the control platform 106 will convert the GIS information into associated polygon IDs. The control platform 106 compares the heartbeat data 902 to the UAV 102 predefined approved flight path. If the UAV 102 is flying within its predefined approved flight path, the control platform 106 will send a message 904 including an acknowledgement response to the UAV 102. If the UAV 102 is flying out of range from the predefined approved flight path, then control platform 106 will send the message 904 including a warning message/response to the UAV 102 to return to its correct predefined path.

When the control platform 106 fails to receive three heartbeats (e.g., the UAV 102 fails to send three heartbeats or the UAV 102 sends the heartbeats but the control platform fails to receive them), the control platforms 106 will generate a heartbeat failure alert and will send the message 904 including an internet protocol (IP) ping command. If the UAV does not respond to the IP ping command within a fail-to-connect predetermined time interval (which can be equivalent to or longer than the predetermined time interval Tms), a failed to connect to the UAV 102 alert message is generated by the control platform 106 and sent to an administrator or parties other than the UAV 102 and the control platform 106 (including, perhaps, the flight authority platform 112) for further action.

Referring to FIG. 10, an illustration 1000 depicts an exemplary heartbeat protocol operation in accordance with the present embodiment wherein a predefined failsafe procedure operates in the absence of appropriate heartbeat data 902. When the UAV 102 fails to receive and regular response messages 904 from the control platform 106 for three consecutive predetermined heartbeat time intervals 1002, the communication link between the control platform 106 and the UAV 102 is deemed broken and the UAV 102 will activate 1002 its failsafe procedure which would preferably include a safe return to base 1006 or some similar predetermined maneuvering of the UAV 102 to a predetermined location.

Additionally, the control platform 106 is tasked with maintaining a secure heartbeat communication with all flying UAVs which obtained flight path approval prior to flying to ensure each UAV always stay connected and under control. When the communication link between the control platform 106 and the UAV 102 is deemed broken, the assigned to the UAV for communication is revoked and the UAV 102 will return to base. In accordance with the present embodiment, the predetermined heartbeat interval and the number of missed heartbeats before the ink is deemed broken are selectable at the system administration side.

Thus, it can be seen that the present embodiment provides a heartbeat protocol and an encryption/decryption method including generating and using a unique secure session key that can be used in any software application transferring data between a control platform and unmanned machine systems such as unmanned aerial vehicles (UAVs) via dedicated network such as a dedicated Long-Term Evolution (LTE) network. To protect transferred data from the interception from attackers, a unique design for a secure handshake protocol ensures information security. A session key (SK1) which is generated from a passphrase of a first ID unique to the unmanned vehicle and a second ID unique to the communication session, thereby providing a unique session key providing strong protection against attackers. A hybrid cryptography mechanism combines asymmetric keys and symmetric keys used to further protect the transfer of data over the network. After hand shaking between the unmanned vehicle and the control platform, a communication channel is established. To ensure the communication channel is still alive, a unique design is provided for a novel and robust heartbeat protocol. The heartbeat protocol is designed and implemented in the application layer.

Thus, in accordance with the present embodiment, a system is provided between a control platform and one or more unmanned vehicles which provides confidential communication, data integrity, authentication and non-repudiation. In regards to confidentiality, encryption techniques in accordance with the present embodiment can protect information and communication from unauthorized access. In regards to data integrity, any data modification by an attacker will result in the digital signature verification to fail at the receiver end. Since the data integrity has been breached, the output provided by the verification algorithm in accordance with the present embodiment will not match, so the receiver can safely reject the message. In regards to authentication, the public key of a sender is used to verify the digital signature in accordance with the present embodiment, which assures that signature has been created only by a sender who possesses the corresponding private key and no one else. In regards to non-repudiation, the digital signature can be used as evidence if any dispute arises in the future.

While exemplary embodiments have been presented in the foregoing detailed description of the invention, it should be appreciated that a vast number of variations exist. It should further be appreciated that the exemplary embodiments are only examples, and are not intended to limit the scope, applicability, operation, or configuration of the invention in any way. Rather, the foregoing detailed description will provide those skilled in the art with a convenient road map for implementing an exemplary embodiment of the invention, it being understood that various changes may be made in the function and arrangement of steps and method of operation described in the exemplary embodiment without departing from the scope of the invention as set forth in the appended claims.

What is claimed is:

1. A heartbeat protocol communication method for an unmanned vehicle system comprising an unmanned vehicle and a control platform, the heartbeat protocol communication method comprising:
the unmanned vehicle transmitting heartbeat data at regular periodic predetermined time intervals, the heartbeat data comprising keep alive application data comprising real-time information pertinent to the unmanned vehicle.

2. The method in accordance with claim 1 wherein the real-time information pertinent to the unmanned vehicle comprises real-time location information corresponding to a location of the unmanned vehicle at the time the unmanned vehicle transmits the heartbeat data.

3. The method in accordance with claim 1 further comprising:
the unmanned vehicle determining whether an acknowledgement response of reception of the heartbeat data by the control platform is received; and
in response to determining that no acknowledgement response is received for a predetermined number of the regular periodic predetermined time intervals, activating a failsafe operation procedure.

4. The method in accordance with claim 3 wherein the step of activating the failsafe operation procedure comprises the unmanned vehicle maneuvering itself to a predetermined location.

5. The method in accordance with claim 1 wherein the step of transmitting the heartbeat data at the regular periodic predetermined time intervals comprises transmitting the heartbeat data at the regular periodic predetermined time intervals on a dedicated transport layer security/secure sockets layer (TSL/SSL) secure channel established with the control platform in a transport layer of the IP communication network.

6. A heartbeat protocol communication method for an unmanned vehicle system comprising an unmanned vehicle and a control platform, the heartbeat protocol communication method comprising:
the control platform determining at regular periodic predetermined time intervals whether heartbeat data transmitted by the unmanned vehicle is received;
the control platform transmitting an acknowledgement response to the unmanned vehicle each time the heartbeat data is received at a regular periodic predetermined time interval; and
the control platform transmitting a heartbeat failure alert to the unmanned vehicle in response to determining no heartbeat data is received from the unmanned vehicle for a predetermined number of the regular periodic predetermined time intervals.

7. The method in accordance with claim 6 wherein the step of transmitting the acknowledgement response to the unmanned vehicle comprises transmitting the acknowledgement response to the unmanned vehicle on a dedicated transport layer security/secure sockets layer (TSL/SSL) secure channel established with the control platform in a transport layer of the IP communication network.

8. The method in accordance with claim 6 wherein the step of transmitting the heartbeat failure alert to the unmanned vehicle comprises transmitting an internet protocol (IP) ping command along with the heartbeat failure alert to the unmanned vehicle.

9. The method in accordance with claim 8 further comprising alerting parties other than the unmanned vehicle in response to the unmanned vehicle not responding to the IP ping command within a fail-to-connect predetermined time interval.

10. The method in accordance with claim 9 wherein the fail-to-connect predetermined time interval is substantially equivalent to the regular periodic predetermined time interval.

11. The method in accordance with claim 9 wherein the step of alerting the parties other than the unmanned vehicle comprises transmitting a failed to connect to the unmanned vehicle alert message to the parties other than the unmanned vehicle.

12. A heartbeat protocol communication method for an unmanned vehicle system comprising an unmanned vehicle transmitting and a control platform receiving heartbeat data on a dedicated internet protocol (IP) communication network, the heartbeat protocol communication method comprising:
the unmanned vehicle transmitting heartbeat data on a dedicated transport layer security/secure sockets layer (TSL/SSL) secure channel established with the control platform in a transport layer of the IP communication network.

13. A method for secure hybrid cryptographic communication comprising:
encrypting message data utilizing symmetric cryptography; and
further encrypting the message data utilizing asymmetric cryptography.

14. The method in accordance with claim 13 wherein the first encrypting step comprises encrypting the message data using a system session key shared by a sender and a receiver of the message data.

15. The method in accordance with claim 14 wherein the system session key is generated by:
generating a passphrase in response at least to a unique piece of information associated with the device and a unique piece of information associated with the one or more communication sessions; and
generating a session key by performing a key derivation function on the passphrase.

16. The method in accordance with claim 13 wherein the second encrypting step comprises encrypting the message data using one or more sets of public keys and private keys, where each of the public keys are shared by a sender and a receiver of the message data and each of the private keys are unique to only one of the sender and the receiver of the message data.

17. A method for encrypted communication during one or more communication sessions with a device, the method comprising:
generating a passphrase in response at least to a unique piece of information associated with the device and a unique piece of information associated with the one or more communication sessions;
generating a session key by performing a key derivation function on the passphrase; and
encrypting data to be transmitted during the one or more communication sessions and decrypting data received during the one or more communication sessions in response to the session key.

18. The method in accordance with claim 17 wherein the one or more communications sessions comprises a single communication session.

19. The method in accordance with claim 17 wherein the step of generating the passphrase comprises:
determining a present location associated with the device in a multidimensional coordinate system; and generating the passphrase in response at least to the unique piece of information associated with the device and information associated with the present location determined during the communication session.

20. The method in accordance with claim 19 wherein the step of generating the session key comprises generating a first session key by performing the key derivation function on a first passphrase, and wherein generating the passphrase comprises generating the first passphrase, the step of generating the first passphrase comprising:
determining a first present location associated with the device in the multidimensional coordinate system; and
generating the passphrase in response at least to the unique piece of information associated with the device and information associated with the first present location determined during the communication session, and
wherein the method further comprises:
determining a second present location associated with the device in the multidimensional coordinate system a predetermined time interval after determining the first present location;
generating a second passphrase in response at least to the unique piece of information associated with the device and information associated with the second present location determined during the communication session; and
generating a second session key by performing the key derivation function on the second passphrase,
wherein encrypting message data comprises encrypting the message data using the second session key after the predetermined time interval from first using the first session key.

21. The method in accordance with claim 17 wherein the device is an unmanned vehicle.

22. The method in accordance with claim 19 wherein the device is an unmanned aerial vehicle, and wherein the multidimensional coordinate system is a three-dimensional Cartesian coordinate system.
